(19) United States
(12) Patent Application Publication
(10) Pub. No.: US 2026/0011051 A1
(43) Pub. Date: Jan. 8, 2026

(54) SEGMENTATION-INFORMED MRI RECONSTRUCTION

(71) Applicant: Siemens Healthineers AG, Forchheim (DE)

(72) Inventors: Mahmoud Mostapha, Princeton, NJ (US); Alice Blondel, Paris (FR); Mariappan S. Nadar, Plainsboro, NJ (US)

(21) Appl. No.: 18/765,677

(22) Filed: Jul. 8, 2024

(51) Int. Cl. G06T 11/00; G06T 7/10

(52) U.S. Cl. CPC G06T 11/003; G06T 7/10; G06T 2207/10088; G06T 2207/20081

(57) ABSTRACT

Systems and methods for segmentation aware reconstruction of under-sampled images while minimizing the appearance of artifacts. A semantic segmentation task is added to the reconstruction model as a surrogate task to focus the reconstruction on the segmented areas. The joint training of a reconstruction model and a segmentation model, and the addition of a loss associated with segmentation, enables a pseudo-attention effect for reconstruction.

### FIELD

This disclosure relates reconstructing under-sampled MRI images.

### BACKGROUND

Magnetic resonance imaging (MRI) is an important and useful imaging modality used in clinical practice. MRI is a non-invasive imaging technology that produces detailed anatomical images. MRI provides images of the body's soft tissues and internal anatomical structures without ionizing radiation. In an example of the use of MRI, Knee MRI is particularly practical in detecting the presence of anterior cruciate ligament (ACL) sprains and meniscal tears. However, due to attempts to reduce the time that is required to acquire the MRI data in order to make the scan more efficient and effective for the patient, the resulting data may be undersampled/sparse. Complex machine learning techniques are required to generate accurate images from this undersampled/sparse data.

### SUMMARY

By way of introduction, the preferred embodiments described below include methods, systems, instructions, and computer readable media for building a reconstruction model for highly under-sampled images while minimizing the appearance of artifacts.

In a first aspect, a method for using a semantic segmentation task as a surrogate task to focus a reconstruction of magnetic resonance data on segmented areas, the method comprising: training a reconstruction model to reconstruct an image from magnetic resonance data; training a segmentation model for segmentation of magnetic resonance images; joint training the reconstruction model and segmentation model end to end, wherein the segmentation model takes the output of the reconstruction model as input, wherein the joint training includes a joint loss comprising at least a segmentation loss and a reconstruction loss; and providing the trained reconstruction model.

In a second aspect, a system for using a clinical task as a surrogate task for reconstruction of magnetic resonance data, the system comprising: a magnetic resonance scanner configured to acquire undersampled magnetic resonance data of a region of a patient; a memory configured to store a reconstruction model and a clinical task model; a processing unit configured to fine tune the reconstruction model by jointly training the reconstruction model and clinical task model end to end, the processing unit configured to input the undersampled magnetic resonance data into the trained reconstruction model which outputs a representation of the region of the patient; a display configured to display the representation

In a third aspect, a method for performing reconstruction on undersampled magnetic resonance data, the method comprising: acquiring the undersampled magnetic resonance data of a region of a patient; applying a reconstruction model, the reconstruction model jointly trained with a segmentation model as a surrogate task to focus the reconstruction of magnetic resonance data on segmented areas; outputting, by reconstruction model, a representation of the region of the patient; and displaying the representation.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

FIG. 1 depicts an example of a system for Segmentation-Informed MRI Reconstruction according to an embodiment.

FIGS. 2A, 2B, 2C, and 2D depict examples of MRI images with artifacts.

FIG. 3 depicts one framework for segmentation-informed reconstruction according to an embodiment.

FIG. 4 depicts an example neural network according to an embodiment.

FIG. 5 depicts an example convolutional neural network according to an embodiment.

FIG. 6 depicts a workflow for training a reconstruction model according to an embodiment.

FIG. 7 depicts an example of applying a reconstruction model according to an embodiment.

### DETAILED DESCRIPTION

Embodiments provide a reconstruction model for highly under-sampled images while minimizing the appearance of artifacts. Embodiments add a semantic segmentation task to the reconstruction model as a surrogate task to focus the reconstruction on the segmented areas. The joint training of a reconstruction model and a segmentation model, and the addition of a loss associated with segmentation, enables a pseudo-attention effect for reconstruction. In addition, using the segmentation model prevents the occurrence of artifacts by the reconstruction model. Specifically, if an artifact emerges distinctly, the segmentation model would fail to correctly identify the region, resulting in a substantial loss penalty. Embodiments provide the segmentation model and a training regime that trains the joint reconstruction-segmentation model end-to-end. This approach enhances reconstruction predictions and improves segmentation predictions of clinically relevant regions (e.g., knee cartilage and ligaments). Embodiments may also be extended to a generic clinical task-informed MRI reconstruction framework that the user can, during deployment, request reconstructions that are either optimal images for general radiology reading, images for detection purposes, or images for estimation tasks.

The disclosed embodiments may be implemented to computationally facilitate processing of medical imaging data and consequently improving and optimizing medical diagnostics. Embodiments leverage the power of artificial intelligence (AI) to enhance the process of MRI reconstruction. A clinical task such as segmentation is added to the reconstruction process resulting in more efficient and accurate reconstruction of sparse data. Embodiments improve predictions at high acceleration by mitigating the appearance of artifacts present in previous work. As used herein, artificial intelligence (AI) is the use of machine learning models to acquire medical data and uncover insights to help improve health outcomes and patient experience that would otherwise be impractical. The segmentation-informed MRI reconstruction described herein allows for more efficient and quicker acquisition and interpretation. The reduced MRI scan time improves patient experience and increases the throughput of MRI facilities. The AI-driven insights may also potentially reduce human errors and improve the reliability of diagnoses. Additionally, faster scans and reduced need for expert reviews enables cost-efficient screening exams.

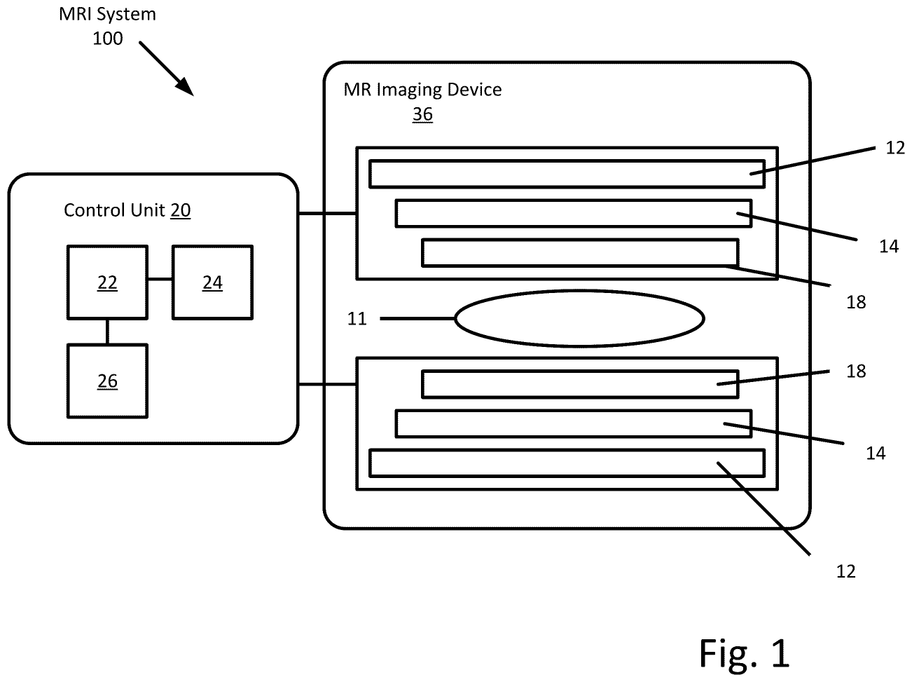

FIG. 1 depicts an example system 100 for segmentation-informed MRI reconstruction. This example is in a magnetic resonance context (i.e., a magnetic resonance scanner), but the reconstruction techniques may be used in reconstruction for CT, PET, SPECT, or other medical imaging. The examples further use a Knee MRI procedure as an example, but any organ or region may be imaged by the system 100. The system 100 uses a segmentation task to inform the reconstruction but other clinical tasks may be used such as harmonization, synthesis, detection, and monitoring among other clinical tasks. In this example, MRI data is acquired by the MR system 100. The MR system 100 includes an MR scanner 36 or system, a computer based on data obtained by MR scanning, a server, or another processor 22. The MR imaging device 36 is only exemplary, and a variety of MR scanning systems may be used to collect the MR data. The MR imaging device 36 (also referred to as a MR scanner or image scanner) is configured to scan a patient 11. The scan provides scan data in a scan domain. The MR imaging device 36 scans a patient 11 to provide k-space measurements (measurements in the frequency domain).

The MR system 100 further includes a control unit 20 configured to process the MR signals and generate (reconstruct) images of the object or patient 11 for display to an operator or further analysis. The control unit 20 includes a processor 22 that is configured to execute instructions, or the method described herein. The control unit 20 may store the MR signals and images in a memory 24 for later processing or viewing. The control unit 20 may include a display 26 for presentation of images to an operator.

In the MR system 100, magnetic coils 12 create a static base or main magnetic field B0 in the body of patient 11 or an object positioned on a table and imaged. Within the magnet system are gradient coils 14 for producing position dependent magnetic field gradients superimposed on the static magnetic field. Gradient coils 14, in response to gradient signals supplied thereto by a gradient and control unit 20, produce position dependent and shimmed magnetic field gradients in three orthogonal directions and generate magnetic field pulse sequences. The shimmed gradients compensate for inhomogeneity and variability in an MR imaging device magnetic field resulting from patient anatomical variation and other sources.

The control unit 20 may include a RF (radio frequency) module that provides RF pulse signals to RF coil 18. The RF coil 18 produces magnetic field pulses that rotate the spins of the protons in the imaged body of the patient 11 by ninety degrees or by one hundred and eighty degrees for so-called “spin echo” imaging, or by angles less than or equal to 90 degrees for “gradient echo” imaging. Gradient and shim coil control modules in conjunction with RF module, as directed by control unit 20, control slice-selection, phase-encoding, readout gradient magnetic fields, radio frequency transmission, and magnetic resonance signal detection, to acquire magnetic resonance signals representing planar slices of the patient 11.

In response to applied RF pulse signals, the RF coil 18 receives MR signals, e.g., signals from the excited protons within the body as the protons return to an equilibrium position established by the static and gradient magnetic fields. The MR signals are detected and processed by a detector within RF module and the control unit 20 to provide an MR dataset to a processor 22 for processing into an image. In some embodiments, the processor 22 is located in the control unit 20, in other embodiments, the processor 22 is located remotely. A two or three-dimensional k-space storage array of individual data elements in a memory 24 of the control unit 20 stores corresponding individual frequency components including an MR dataset. The k-space array of individual data elements includes a designated center, and individual data elements individually include a radius to the designated center.

A magnetic field generator (including coils 12, 14 and 18) generates a magnetic field for use in acquiring multiple individual frequency components corresponding to individual data elements in the storage array. A storage processor in the control unit 20 stores individual frequency components acquired using the magnetic field in corresponding individual data elements in the array. The row and/or column of corresponding individual data elements alternately increases and decreases as multiple sequential individual frequency components are acquired. The magnetic field generator acquires individual frequency components in an order corresponding to a sequence of substantially adjacent individual data elements in the array, and magnetic field gradient change between successively acquired frequency components is substantially minimized.

The control unit 20 may use information stored in an internal database to process the detected MR signals in a coordinated manner to generate high quality images of a selected slice(s) of the body (e.g., using the image data processor) and adjusts other parameters of the system 100. The stored information includes a predetermined pulse sequence of an imaging protocol and a magnetic field gradient and strength data as well as data indicating timing, orientation, and spatial volume of gradient magnetic fields to be applied in imaging.

The MR imaging device 36 is configured by the imaging protocol to scan a region of a patient 11. For example, in MR, such protocols for scanning a patient 11 for a given examination or appointment include diffusion-weighted imaging (acquisition of multiple b-values, averages, and/or diffusion directions), turbo-spin-echo imaging (acquisition of multiple averages), or contrast. In one embodiment, the protocol is for compressed sensing.

One limitation of MRI is acquisition time. In the example of a Knee MRI procedure, a complete acquisition may take between 15 and 20 minutes. This high acquisition time not only results in an unpleasant patient experience, as the patient is immobilized in a tube for the whole duration of the acquisition (which is not always possible for disabled people or children, for example), but also risks compromising the quality of the acquisition by increasing the risk of patient movement. It is, therefore, crucial to reduce this acquisition time as much as possible. Two acceleration methods have been developed that may be used individually or in combination. A first approach, Parallel Imaging Acceleration (PAT) involves sub-sampling the acquisition space. A second approach Simultaneous Multi-Slice (SMS) involves acquiring several slices simultaneously. An SMS factor of 2 means that two images are acquired simultaneously, and a PAT factor of 2 means that only half of the data is acquired. An acquisition that would take 20 minutes would last 5 minutes for a PAT 2 SMS 2 acquisition. With these techniques, MRI reconstruction becomes an inverse problem of reconstructing a fully-sampled image from the under-sampled data. Deep learning pipelines have been used to address this problem, achieving state-of-the-art performance with high acceleration factors. Beyond a specific acceleration factor, however, there is a risk that the model might hallucinate details and trigger the emergence of artifacts.

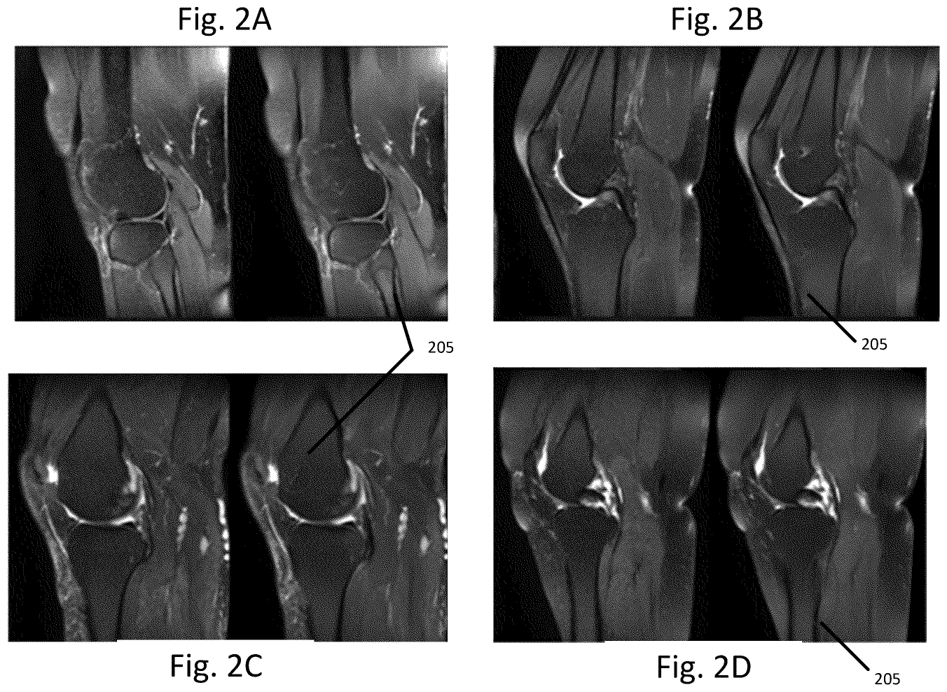

In an example of a previous attempt, a complete DL approach for combined slice separation and k-space-to-image reconstruction of SMS-PI-accelerated knee scans has been used. However, such an approach at higher accelerations (e.g., SMS2 with PAT6 and PAT8) still suffers from significant image quality degradation, including a large signal-to-noise ratio (SNR) drop and inter-slice leakage and aliasing artifacts. FIGS. 2A-2D depict four examples of artifact occurrence in PAT8 image reconstruction. For each example, the target is displayed on the left, and the prediction on the right. The artifacts 205 are highlighted with a solid outline. The first three examples (FIGS. 2A-2C) are aliasing artifacts, and the source of aliasing is marked with a dashed outline. In the last example (FIG. 2D), the boundary between the tibia and fat is poorly reconstructed, so the region corresponding to the tibia cannot be accurately defined. Hence, there is still a need for improved methods to bridge that gap in performance compared to lower acceleration factors.

Another limitation of the previous approach is that it employs a loss function that assigns equal importance to all pixels in the image, here, an L1 loss. However, certain areas are more critical for diagnostic determination. This uniform weighting of loss contributions may not be ideal when the diagnosis primarily concerns specific regions within the field of view. In the context of T2 Knee MRI, the primary objective is to identify the presence of meniscus lesions or edema. Thus, the region of interest primarily encompasses the menisci and bones.

Embodiments provide a method to prevent artifact appearance and focus the reconstruction on specific regions. Embodiments include a clinical task (for example semantic segmentation) as a surrogate task. The joint training of a reconstruction model and a segmentation model, and the addition of a loss associated with segmentation, enables a pseudo-attention effect for reconstruction. This approach leverages the back-propagation of segmentation errors to direct the focus of the reconstruction model toward the segmented areas. The addition of a segmentation model prevents the appearance of artifacts by the reconstruction model. In an example, if an artifact arises, the segmentation model struggles to identify the affected area accurately or exhibits reduced confidence, thereby significantly penalizing the loss function.

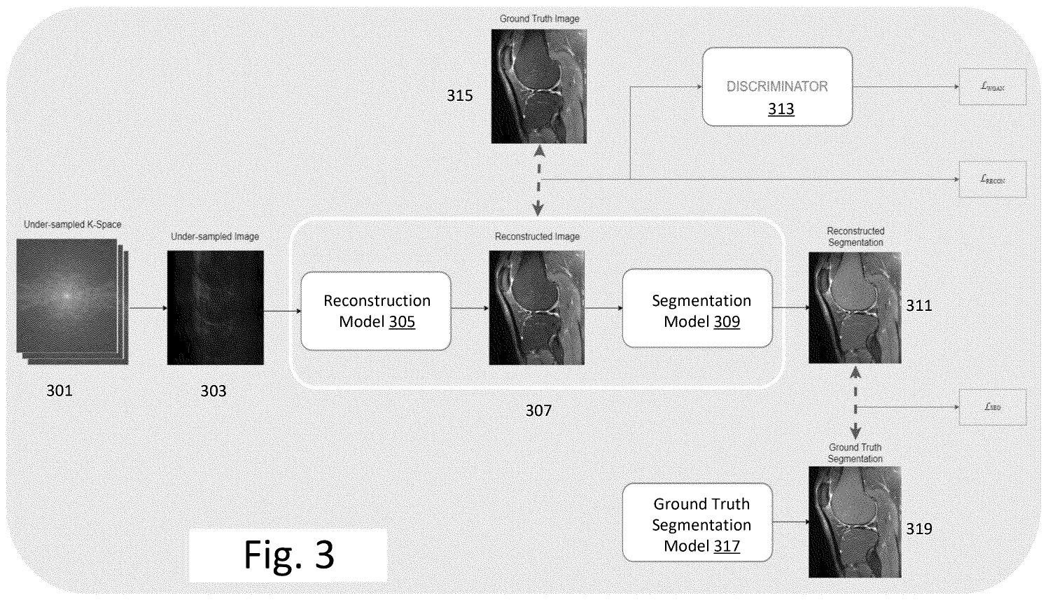

Embodiments further include an end-to-end training pipeline of the reconstruction and segmentation models to achieve high-quality reconstructions in specific regions of interest while preventing the appearance of artifacts. During the training phase, sequential end-to-end training of a reconstruction model and a segmentation model is performed. FIG. 3 depicts one framework for segmentation-informed reconstruction. Under sampled K-space data 301 is acquired, for example by the system 100. An under sampled image 303 may be provided or otherwise input into the reconstruction model 305. The reconstruction model 305 (also referred to as a generator 305 as part of the GAN) outputs a reconstructed image 307. The reconstructed image is compared to a ground truth image to provide a reconstruction loss. The reconstructed image is also provided to a discriminator 313 which provides a WGAN loss. The reconstructed image is also used as the input to a segmentation model 309 (also referred to as a segmentation network 309). The segmentation model 309 takes the output of the reconstruction model 305 as input and outputs a reconstructed segmentation 311. The reconstructed segmentation 311 is compared to a ground truth segmentation image 317 provided by a ground truth segmentation model 317 generating a segmentation loss. During an imaging procedure, image reconstruction may be performed solely using the reconstruction model 305. The segmentation model 309 may be used for further analysis. The framework is versatile, allowing for the utilization of various state-of-the-art architectures for both the reconstruction and segmentation modules.

As depicted in FIG. 3, two supervised losses are calculated: one between the target image and the reconstructed image, referred to as the reconstruction loss, and the other between the segmentation target and the segmentation predictions, referred to as the segmentation loss. A discriminator model is also applied to the reconstructed image to generate a WGAN loss. The reconstruction loss may be an L1 complex (applied directly on complex images), and the segmentation loss may be computed using a cross-entropy.

Training compound networks may be volatile and susceptible to convergence towards local minima, leading to suboptimal performance from either or both networks. In the initial training phases, the segmentation model 309 receives input generated by a reconstruction model 305 that is not yet sufficiently trained, potentially resulting in input data with many reconstruction artifacts. This will impact the segmentation model's learning process, leading to inaccurate segmentation maps. Then, a poorly performing segmentation model 309 would provide misleading guidance to the reconstruction model 305. This interdependence can create a vicious cycle in which both networks are adversely affected. Embodiments described herein pre-train the segmentation and reconstruction models independently until convergence. The segmentation model 309 is trained using the ground truth MRI images. Subsequently, both models are jointly trained. During this phase, the segmentation model 309 takes the output of the reconstruction model 305 as input.

Referring back to FIG. 1, the embodiments may be implemented using the control unit 20 of the MR system or another computing system. The control unit 20 is configured to reconstruct a representation of the patient from the MR data from the MR system 100. The control unit 20 is configured to implement one or more AI based models that are trained/configured to input data and output the representation. The models may be trained/configured by the control unit 20 and/or another computing system. In an example, the reconstruction model 305 and segmentation model 309 may be trained by another device and then one trained, implemented by the control unit 20 to process newly acquired MR data of the patient 22. In another example, the reconstruction model 305 and segmentation model 309 may be applied to the MR data using another computing system located at the imaging facility or, for example, located in the cloud.

The control unit 20 includes one or more processors 22. The one or more processors 22 may include a general processor, digital signal processor, three-dimensional data processor, graphics processing unit, application specific integrated circuit, field programmable gate array, artificial intelligence processor, digital circuit, analog circuit, combinations thereof, or another now known or later developed device for reconstruction using one or more AI based models. The processor 22 may be a single device, a plurality of devices, or a network. For more than one device, parallel or sequential division of processing may be used. Different devices making up the processor may perform different functions. In one embodiment, the processor 22 is a control processor or other processor of the MR scanner 100. Other processors of the MR scanner 100 or external to the MR scanner 100 may be used. The processor 22 is configured by software, firmware, and/or hardware to reconstruct. The instructions for implementing the processes, methods, and/or techniques discussed herein are provided on non-transitory computer-readable storage media or memories, such as a cache, buffer, RAM, removable media, hard drive, or other computer readable storage media. The instructions are executable by the processor or another processor. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the instructions set, storage media, processor or processing strategy and may be performed by software, hardware, integrated circuits, firmware, micro code, and the like, operating alone or in combination. In one embodiment, the instructions are stored on a removable media device for reading by local or remote systems. In other embodiments, the instructions are stored in a remote location for transfer through a computer network. In yet other embodiments, the instructions are stored within a given computer, CPU, GPU, or system. Because some of the constituent system components and method steps depicted in the accompanying figures may be implemented in software, the actual connections between the system components (or the process steps) may differ depending upon the manner in which the present embodiments are programmed.

The control unit 20 is configured to reconstruct a representation of a scan region, such as a region or organ of the patient using one or more models, for example a reconstruction model 305 and a clinical task model 309 (segmentation model 309). The control unit 20 may use, for example, the image processor 22 that is configured to reconstruct a representation in an object domain. The representation or object in the object domain is reconstructed from the scan data in the scan domain. The scan data is a set or frame of k-space data from a scan of the patient. The object domain is an image space and corresponds to the spatial distribution of the patient. A planar or volume representation or object is reconstructed as an image representing the patient. For example, pixels values representing tissue in an area or voxel values representing tissue distributed in a volume are generated.

In embodiments, the reconstruction is performed, at least in part, using a machine-learned model or algorithm such as a reconstruction model 305 and clinical task model 309. The machine-learned model is formed from one or more networks and/or other machine-learned arrangements. For an example used herein, the reconstruction model 305 includes one or more deep-learned neural networks included in an unrolled iterative reconstruction algorithm. A machine-learned model is used for at least part of the reconstruction, such as regularization of reconstruction. In regularization, image or object domain data is input, and image or object domain data with less artifact is output. The remaining portions or stages of the reconstruction (e.g., Fourier transform and gradients in iterative optimization) are performed using reconstruction algorithms and/or other machine-learned networks. In other embodiments, a machine-learned model is used for all the reconstruction operations (one model to input k-space data and output regularized image data) or other reconstruction operations (e.g., used for transform, gradient operation, and/or regularization). The reconstruction is of an object or image domain from projections or measurements in another domain, and the machine-learned model is used for at least part of the reconstruction.

In certain embodiments, the machine-learned model is part of an unrolled iterative reconstruction. For example, the machine-learned model implements a regularization function in the unrolled iterative reconstruction. An unrolled proximal gradient algorithm with Nesterov momentum includes a convolutional neural network (CNN) for regularization. To produce sharp reconstructions from input under-sampled (compressed sensing) multi-coil (parallel imaging) k-space data, such network is first trained to minimize a combined L1 and a multi-scale version of the structural similarity (SSIM) content losses between network prediction and ground truth images for regularization. Other losses may be used, such as using just the L1 loss. The same or different machine-learned model or network (e.g., CNN) is used for each or some of the unrolled iterations. The CNN for regularization may be refined, such as using a semi-supervised refinement applied in a subsequent training step where an adversarial loss is based on Wasserstein Generative Adversarial Networks (WGAN). The learnable parameters of the architecture of the reconstruction model 305 are trained for altering the characteristic or characteristics, such as for denoising (removing or reducing noise). In the compressed sensing embodiment, the ground truth representation for training may be reconstructions formed from full sampling, so having reduced noise. Other ground truth representations may be used, such as generated by simulation or application of a denoising or other characteristic altering algorithm.

The reconstruction may output the representation as pixels, voxels, and/or a display formatted image in response to the input. The learned values and network architecture, with any algorithms (e.g., extrapolation and gradient update) determine the output from the input. The output of the reconstruction, such the output of the machine-learned model, is a two-dimensional distribution of pixels representing an area of the patient and/or a three-dimensional distribution of voxels representing a volume of the patient. The output from the last reconstruction iteration may be used as the output representation of the patient.

A computer (e.g., processor 22) machine trains the reconstruction model 305. The reconstruction model 305 is machine trained using a supervised process and training data. The training data includes many sets of data, such as representations output by reconstruction and the corresponding ground truth. Tens, hundreds, or thousands of samples are acquired, such as from scans of volunteers or patients, scans of phantoms, simulation of scanning, and/or by image processing to create further samples. Many examples that may result from different scan settings, patient anatomy, scanner characteristics, or other variance that results in different samples are used. In one embodiment, an already gathered or created MR dataset is used for the training data. The samples are used in machine learning (e.g., deep learning) to determine the values of the learnable variables (e.g., values for convolution kernels) that produce outputs with minimized cost or loss across the variance of the different samples.

The training learns both the features of the input data and the conversion of those features to the desired output. Backpropagation, RMSprop, ADAM, or another optimization is used in learning the values of the learnable parameters of the network (e.g., the convolutional neural network (CNN) or fully connection network (FCN)). Where the training is supervised, the differences (e.g., L1, L2, mean square error, or other loss) between the estimated output and the ground truth output are minimized.

In an embodiment, the reconstruction model 305 may be trained using an adversarial training process, e.g., the model may include a generative adversarial network (GAN). For an adversarial training approach, a generative reconstruction model 305 and a discriminative network are provided for training by the devices. The generative reconstruction model 305 is trained to identify the features of data and generate a representation that is indistinguishable from the ground truth data. In the training process, the discriminative network plays the role of a judge to score how well the generator performed. The discriminator provides a GAN loss, in particular a Wasserstein GAN loss.

A segmentation model 309 is also used to generate a reconstructed segmentation which provides a segmentation loss when compared with a ground truth segmentation. Machine learning for image segmentation may be done by extracting a selection of features from input images. These features may include, for example, pixel gray levels, pixel locations, image moments, information about a pixel's neighborhood, etc. A vector of image features is then fed into a learned classifier which classifies each pixel of the image into a class. The parameters of the classifier are learned automatically by giving the classifier input images for which the ground truth classification results is known, for example from manual or automatically annotated images. The output of the model is then compared to the ground truth, and the parameters of the model are adjusted so that the model's output better matches the ground truth value. This procedure is repeated for a large amount of input images, so that the learned parameters generalize to new, unseen examples. Deep learning may be used for segmentation (and other tasks described herein), for example using a neural network. Deep learning-based image segmentation may be done, for example, using a convolutional neural network (CNN). The convolutional neural network includes a layered structure where series of convolutions are performed on an input image. Kernels of the convolutions are learned during training. The convolution results are then combined using a learned statistical model that outputs a segmented image.

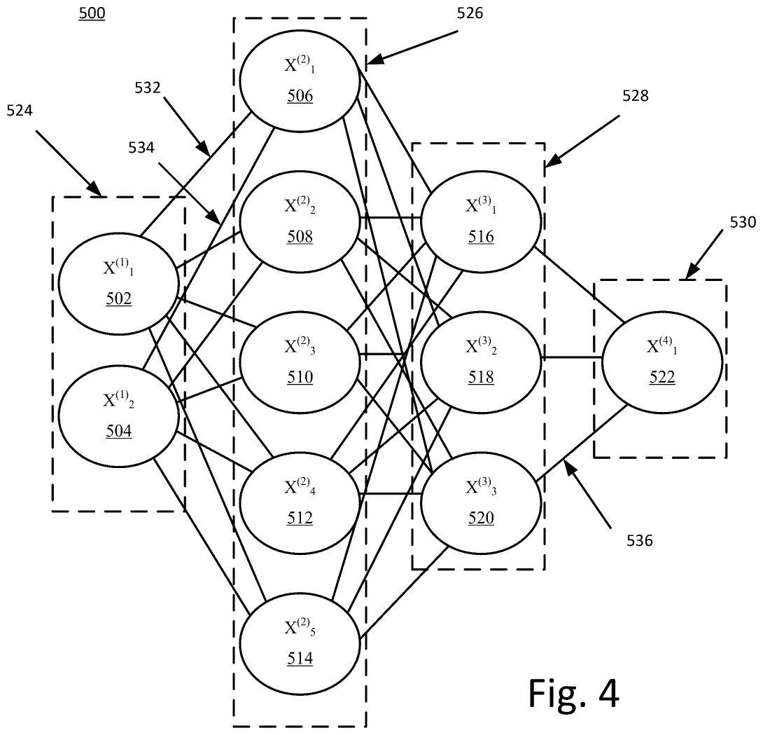

FIG. 4 shows an embodiment of an artificial neural network 500, in accordance with one or more embodiments. Alternative terms for “artificial neural network” are “neural network”, “artificial neural net” or “neural net”. The artificial neural network 500 may be used in part in, for example, the one or more machine learning based networks utilized for the reconstruction model 305, clinical task model 309, or segmentation model 309.

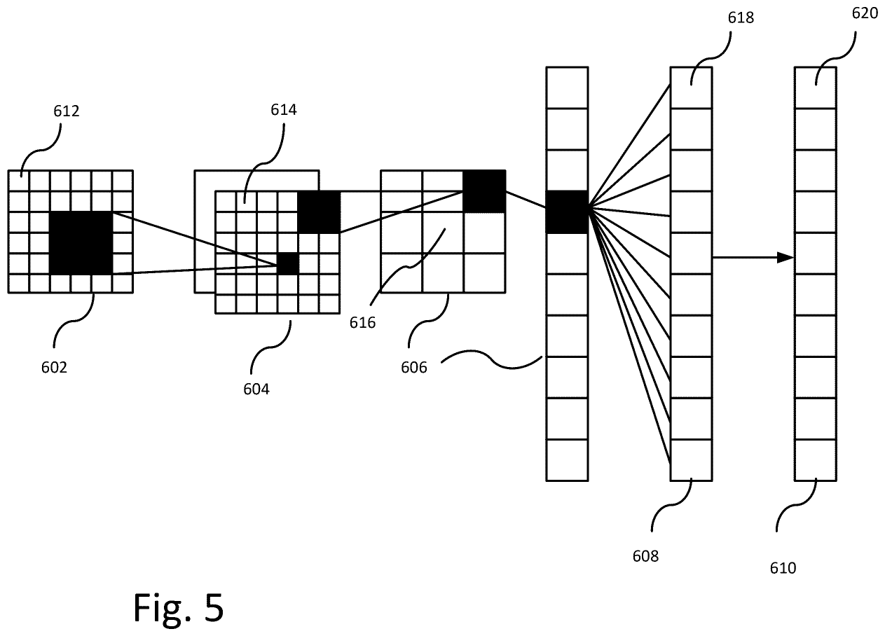

The artificial neural network 500 includes nodes 502-522 and edges 532, 534, . . . , 536, wherein each edge 532, 534, . . . , 536 is a directed connection from a first node 502-522 to a second node 502-522. In general, the first node 502-522 and the second node 502-522 are different nodes 502-522, it is also possible that the first node 502-522 and the second node 502-522 are identical. For example, in FIG. 5, the edge 532 is a directed connection from the node 502 to the node 506, and the edge 534 is a directed connection from the node 504 to the node 506. An edge 532, 534, . . . , 536 from a first node 502-522 to a second node 502-522 is also denoted as “ingoing edge” for the second node 502-522 and as “outgoing edge” for the first node 502-522.

In this embodiment, the nodes 502-522 of the artificial neural network 500 may be arranged in layers 524-530, wherein the layers may include an intrinsic order introduced by the edges 532, 534, . . . , 536 between the nodes 502-522. In particular, edges 532, 534, . . . , 536 may exist only between neighboring layers of nodes. In the embodiment shown in FIG. 5, there is an input layer 524 including only nodes 502 and 504 without an incoming edge, an output layer 530 including only node 522 without outgoing edges, and hidden layers 526, 528 in-between the input layer 524 and the output layer 530. In general, the number of hidden layers 526, 528 may be chosen arbitrarily. The number of nodes 502 and 504 within the input layer 524 usually relates to the number of input values of the neural network 500, and the number of nodes 522 within the output layer 530 usually relates to the number of output values of the neural network 500.

In particular, a (real) number may be assigned as a value to every node 502-522 of the neural network 500. Here, x⁽ⁿ⁾ᵢ denotes the value of the i-th node 502-522 of the n-th layer 524-530. The values of the nodes 502-522 of the input layer 524 are equivalent to the input values of the neural network 500, the value of the node 522 of the output layer 530 is equivalent to the output value of the neural network 500. Furthermore, each edge 532, 534, . . . , 536 may include a weight being a real number, in particular, the weight is a real number within the interval [−1, 1] or within the interval [0, 1]. Here, w^{(m,n)}_{i,j} denotes the weight of the edge between the i-th node 502-522 of the m-th layer 524-530 and the j-th node 502-522 of the n-th layer 524-530. Furthermore, the abbreviation w⁽ⁿ⁾_{i,j} is defined for the weight w^{(n,n+1)}_{i,j}.

In particular, to calculate the output values of the neural network 500, the input values are propagated through the neural network. In particular, the values of the nodes 502-522 of the (n+1)-th layer 524-530 may be calculated based on the values of the nodes 502-522 of the n-th layer 524-530 by

$${x}_{j}^{( n + 1 )} = f ( {\sum }_{i} {x}_{i}^{( n )} \cdot {w}_{i , j}^{( n )} ) .$$

Herein, the function f is a transfer function (another term is “activation function”). Known transfer functions are step functions, sigmoid function (e.g. the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 524 are given by the input of the neural network 500, wherein values of the first hidden layer 526 may be calculated based on the values of the input layer 524 of the neural network, wherein values of the second hidden layer 528 may be calculated based in the values of the first hidden layer 526, etc.

In order to set the values w^{(m,n)}_{i,j} for the edges, the neural network 500 has to be trained using training data. In particular, training data includes training input data and training output data (denoted as tᵢ). For a training step, the neural network 500 is applied to the training input data to generate calculated output data. In particular, the training data and the calculated output data include a number of values, said number being equal with the number of nodes of the output layer.

In particular, a comparison between the calculated output data and the training data is used to recursively adapt the weights within the neural network 500 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δ⁽ⁿ⁾ⱼ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δ⁽ⁿ⁺¹⁾ⱼ, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 530, wherein f′ is the first derivative of the activation function, and y⁽ⁿ⁺¹⁾ⱼ is the comparison training value for the j-th node of the output layer 530.

FIG. 5 shows a convolutional neural network 600, in accordance with one or more embodiments. Machine learning networks described herein, such as, e.g., a segmentation encoder/decoder network may be implemented using convolutional neural network 600.

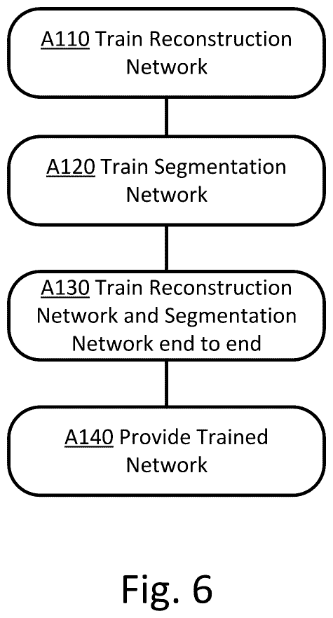

In the embodiment shown in FIG. 6, the convolutional neural network includes 600 an input layer 602, a convolutional layer 604, a pooling layer 606, a fully connected layer 608, and an output layer 610. Alternatively, the convolutional neural network 600 may include several convolutional layers 604, several pooling layers 606, and several fully connected layers 608, as well as other types of layers. The order of the layers may be chosen arbitrarily, usually fully connected layers 608 are used as the last layers before the output layer 610.

In particular, within a convolutional neural network 600, the nodes 612-620 of one layer 602-610 may be considered to be arranged as a d-dimensional matrix or as a d-dimensional image. In particular, in the two-dimensional case the value of the node 612-620 indexed with i and j in the n-th layer 602-610 may be denoted as xⁿ_{)[i,j]}. However, the arrangement of the nodes 612-620 of one layer 602-610 does not have an effect on the calculations executed within the convolutional neural network 600 as such, since these are given solely by the structure and the weights of the edges.

In particular, a convolutional layer 604 is characterized by the structure and the weights of the incoming edges forming a convolution operation based on a certain number of kernels. In particular, the structure and the weights of the incoming edges are chosen such that the values x⁽ⁿ⁾ₖ of the nodes 614 of the convolutional layer 604 are calculated as a convolution x⁽ⁿ⁾ₖ=Kₖ*x⁽ⁿ⁻¹⁾ based on the values x⁽ⁿ⁻¹⁾ of the nodes 612 of the preceding layer 602, where the convolution * is defined in the two-dimensional case as:

$${x}_{k}^{( n )} [ i , j ] = ( {K}_{{k}^{*}} {x}^{( n - 1 )} ) [ i , j ] = {\sum }_{{i}^{′}} {\sum }_{{j}^{′}} {K}_{k} [ {i}^{′} , {j}^{′} ] \cdot {x}^{( n - 1 )} [ i - {i}^{′} , j - {j}^{′} ] .$$

Here the k-th kernel Kₖ is a d-dimensional matrix (in this embodiment a two-dimensional matrix), which is usually small compared to the number of nodes 612-618 (e.g. a 3×3 matrix, or a 5×5 matrix). In particular, this implies that the weights of the incoming edges are not independent, but chosen such that they produce said convolution equation. In particular, for a kernel being a 3×3 matrix, there are only 9 independent weights (each entry of the kernel matrix corresponding to one independent weight), irrespectively of the number of nodes 612-620 in the respective layer 602-610. In particular, for a convolutional layer 604, the number of nodes 614 in the convolutional layer is equivalent to the number of nodes 612 in the preceding layer 602 multiplied with the number of kernels.

If the nodes 612 of the preceding layer 602 are arranged as a d-dimensional matrix, using a plurality of kernels may be interpreted as adding a further dimension (denoted as “depth” dimension), so that the nodes 614 of the convolutional layer 604 are arranged as a (d+1)-dimensional matrix. If the nodes 612 of the preceding layer 602 are already arranged as a (d+1)-dimensional matrix including a depth dimension, using a plurality of kernels may be interpreted as expanding along the depth dimension, so that the nodes 614 of the convolutional layer 604 are arranged also as a (d+1)-dimensional matrix, wherein the size of the (d+1)-dimensional matrix with respect to the depth dimension is by a factor of the number of kernels larger than in the preceding layer 602.

The advantage of using convolutional layers 604 is that spatially local correlation of the input data may exploited by enforcing a local connectivity pattern between nodes of adjacent layers, in particular by each node being connected to only a small region of the nodes of the preceding layer.

In embodiment shown in FIG. 6, the input layer 602 includes 36 nodes 612, arranged as a two-dimensional 6×6 matrix. The convolutional layer 604 includes 72 nodes 614, arranged as two two-dimensional 6×6 matrices, each of the two matrices being the result of a convolution of the values of the input layer with a kernel. Equivalently, the nodes 614 of the convolutional layer 604 may be interpreted as arranges as a three-dimensional 6×6×2 matrix, wherein the last dimension is the depth dimension.

A pooling layer 606 may be characterized by the structure and the weights of the incoming edges and the activation function of its nodes 616 forming a pooling operation based on a non-linear pooling function f. For example, in the two dimensional case the values x⁽ⁿ⁾ of the nodes 616 of the pooling layer 606 may be calculated based on the values x⁽ⁿ⁻¹⁾ of the nodes 614 of the preceding layer 604 as

$${x}^{( n )} [ i , j ] = f ( {x}^{( n - 1 )} [ {id}_{1} , {jd}_{2} ] , … , {x}^{( n - 1 )} [ i {d}_{1} + {d}_{1} - 1 , j {d}_{2} + {d}_{2} - 1 ] )$$

In other words, by using a pooling layer 606, the number of nodes 614, 616 may be reduced, by replacing a number d1·d2 of neighboring nodes 614 in the preceding layer 604 with a single node 616 being calculated as a function of the values of said number of neighboring nodes in the pooling layer. In particular, the pooling function f may be the max-function, the average or the L2-Norm. In particular, for a pooling layer 606 the weights of the incoming edges are fixed and are not modified by training.

The advantage of using a pooling layer 606 is that the number of nodes 614, 616 and the number of parameters is reduced. This leads to the amount of computation in the network being reduced and to a control of overfitting.

In the embodiment shown in FIG. 6, the pooling layer 606 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

A fully-connected layer 608 may be characterized by the fact that a majority, in particular, all edges between nodes 616 of the previous layer 606 and the nodes 618 of the fully-connected layer 608 are present, and wherein the weight of each of the edges may be adjusted individually.

In this embodiment, the nodes 616 of the preceding layer 606 of the fully-connected layer 608 are displayed both as two-dimensional matrices, and additionally as non-related nodes (indicated as a line of nodes, wherein the number of nodes was reduced for a better presentability). In this embodiment, the number of nodes 618 in the fully connected layer 608 is equal to the number of nodes 616 in the preceding layer 606. Alternatively, the number of nodes 616, 618 may differ.

Furthermore, in this embodiment, the values of the nodes 620 of the output layer 610 are determined by applying the Softmax function onto the values of the nodes 618 of the preceding layer 608. By applying the Softmax function, the sum the values of all nodes 620 of the output layer 610 is 1, and all values of all nodes 620 of the output layer are real numbers between 0 and 1.

A convolutional neural network 600 may also include a ReLU (rectified linear units) layer or activation layers with non-linear transfer functions. In particular, the number of nodes and the structure of the nodes contained in a ReLU layer is equivalent to the number of nodes and the structure of the nodes contained in the preceding layer. In particular, the value of each node in the ReLU layer is calculated by applying a rectifying function to the value of the corresponding node of the preceding layer.

The input and output of different convolutional neural network blocks may be wired using summation (residual/dense neural networks), element-wise multiplication (attention) or other differentiable operators. Therefore, the convolutional neural network architecture may be nested rather than being sequential if the whole pipeline is differentiable.

In particular, convolutional neural networks 600 may be trained based on the backpropagation algorithm. For preventing overfitting, methods of regularization may be used, e.g. dropout of nodes 612-620, stochastic pooling, use of artificial data, weight decay based on the L1 or the L2 norm, or max norm constraints. Different loss functions may be combined for training the same neural network to reflect the joint training objectives. A subset of the neural network parameters may be excluded from optimization to retain the weights pretrained on another datasets.

FIG. 6 depicts a method for training/configuring the reconstruction model 305. A segmentation model 309 and a segmentation loss are added to the reconstruction process. The reconstruction model 305 and segmentation model 309 are trained separated then the joint reconstruction-segmentation model 309 is trained/fine-tuned end-to-end. The acts are performed by the system of FIGS. 1, 3, 4, 5, other systems, a workstation, a computer, and/or a server. Additional, different, or fewer acts may be provided. The acts are performed in the order shown (e.g., top to bottom) or other orders. Certain acts may be omitted or changed depending on the results of the previous acts and the status of the patient.

At A110, a reconstruction model 305 is trained to reconstruct an image from magnetic resonance data. In an embodiment, the reconstruction model 305 is trained using a generative adversarial process (GAN). The GAN includes two loss functions: one for generator training and one for discriminator training. In an embodiment, loss is a Wasserstein loss (WGAN loss). This loss function depends on a modification of the GAN scheme (called “Wasserstein GAN” or “WGAN”) in which the discriminator does not actually classify instances, instead the WGAN outputs a number. The discriminator training tries to make the number bigger for real instances than for fake instances. In this case, the WGAN discriminator may be referred to as a “critic” instead of a “discriminator” since the discriminator does not discriminate between real and fake but rather judges the output of the generator. In an embodiment, the Critic Loss is D(x)−D(G(z)) where the discriminator tries to maximize this function, for example, tries to maximize the difference between its output on real instances and its output on fake instances. The Generator Loss is D(G(z)) and the generator tries to maximize this function, e.g., tries to maximize the discriminator's output for its fake instances. In these functions: D(x) is the critic's output for a real instance. G(z) is the generator's output when given noise z. D(G(z)) is the critic's output for a fake instance. The formulas derive from the earth mover distance between the real and generated distributions.

During the training process, the reconstruction model 305 attempts to generate output that can fool the discriminator network into thinking that the output is from the training set of data. In the adversarial process, the reconstruction model 305 may be trained to minimize the sum of two losses: a supervised L1 distance of the reconstruction prediction, and an unsupervised adversarial term. The adversarial term is provided by the discriminator network. While the reconstruction model 305 is being trained, the discriminator network is also adjusted to provide better feedback to the reconstruction model 305.

The discriminator network may use probability distributions of the real images (ground truth/training data) and the reconstruction images to classify and distinguish between the two types of images. The discriminator network provides the information to the reconstruction model 305. The information provided by the discriminator network may be in the form of a gradient that is calculated as a function of a comparison of the probability distributions of the images, e.g. comparing a first probability distribution of values for the generated image with an expected probability distribution of values for the ground truth image. The gradient may include both a direction and a slope that steer updates for the generator network in the right direction. After a number of iterations, the gradient directs the reconstruction model 305 to a stable place where the reconstruction model 305 is generating images with probability distributions that are similar to the ground truth images. As the generator improves with training, the discriminator performance gets worse because the discriminator can't easily tell the difference between real and fake. If the generator succeeds perfectly, then the discriminator has a 50% accuracy. In effect, the discriminator flips a coin to make its prediction. The gradients provided by the discriminator network change as the reconstruction model 305 generates and provides new images.

The training data for the reconstruction model 305 may include ground truth data or gold standard data. Ground truth data and gold standard data is data that includes correct or reasonably accurate labels. For the segmentation model 309 described below, the training data includes the original data and associated segmented data, for example provided by the ground truth segmentation model 317. Labels for segmentation purposes include labels for each pixel/voxel in the segmented data. The segmented data may be generated and labeled using any method or process, for example, manually by an operator or automatically by one or more automatic methods such as the ground truth segmentation model 317. Different training data may be acquired for different segmentation tasks. For example, a first set of training data may be used to train a first network for segmenting Knee data, while a second set of training data may be used to train a second network for segmenting heart data. The training data may be acquired at any point prior to inputting the training data into the trained network. The training data may include volumes of different resolutions or contrast. The training data may be updated after acquiring new data. The updated training data may be used to retrain or update the trained network. The output of act A110 is a trained reconstruction model 305.

At A120, a segmentation model 309 is trained for segmentation of magnetic resonance images. The segmentation model 309 and reconstruction model 305 are initially trained separately and then fine-tuned end to end in step A130 described below. In an embodiment, the segmentation model 309 may be an image-to-image network, such as a fully convolutional U-net trained to convert an input image to a segmented image. The trained convolution units, weights, links, and/or other characteristics of the network are applied to the data of the two dimensional images and/or derived feature values to extract the corresponding features through a plurality of layers and output the segmentation. The features of the input are extracted from the images. Other more abstract features may be extracted from those extracted features using the architecture. Depending on the number and/or arrangement of units or layers, other features are extracted from the input. The network includes an encoder (convolutional) network and decoder (transposed-convolutional) network forming a “U” shape with a connection between passing features at a greatest level of compression or abstractness from the encoder to the decoder. Skip connections may be provided. Any now known or later developed U-Net architectures may be used. Other fully convolutional networks may be used. In one embodiment, the network is a U-Net with one or more skip connections. The skip connections pass features from the encoder to the decoder at other levels of abstraction or resolution than the most abstract (i.e. other than the bottleneck). Skip connections provide more information to the decoding layers. A fully convolutional layer may be at the bottleneck of the network (i.e., between the encoder and decoder at a most abstract level of layers). The fully connected layer may make sure as much information as possible is encoded. Batch normalization may be added to stabilize the training.

Other machine training architectures for segmentation may be used. Similarly for other tasks described herein, different machine training architectures may be used. For example, a U-Net is used as described above. A convolutional-to-transposed-convolutional network may be used. One segment of layers or units applies convolution to increase abstractness or compression. The most abstract feature values are then output to another segment. The other segment of layers or units then applies transposed convolution to decrease abstractness or compression, resulting in outputting of an indication of class membership by location. The architecture may be a fully convolutional network. Other deep networks may be used. The machine learned network/model outputs a segmented image.

In an embodiment, the segmentation model 309 includes an image encoder that computes an image embedding and a lightweight mask decoder that predicts segmentation masks. The lightweight model is used so that the training of the reconstruction-segmentation model 309 can primarily focus on the reconstruction task.

Training of the segmentation model 309 includes inputting an image to the segmentation model 309 which outputs a segmented image. The output segmented image is compared against the training data to determine a score. The score may represent the level of differences between the output segmented data and the correct segmented data (ground truth or gold standard) provided with the training data. The score is used to adjust weights of the segmentation model 309 using, for example, backpropagation and a gradient. This process is repeated multiple times until the difference between the output and the ground truth is acceptable. The segmentation loss may use any segmentation-based evaluation metric, or even multiple metrics predicted simultaneously. Different metrics that may be used may include DICE, Jaccard, true positive rate, true negative rate, modified Hausdorff, volumetric similarity, or others. DICE is a measure of the comparison between two different images or sets of values. The Jaccard index (JAC) between two sets is defined as the intersection between them divided by their union. True Positive Rate (TPR), also called Sensitivity and Recall, measures the portion of positive voxels in the ground truth that are also identified as positive by the segmentation being evaluated. Analogously, True Negative Rate (TNR), also called Specificity, measures the portion of negative voxels (background) in the ground truth segmentation that are also identified as negative by the segmentation being evaluated. The output of act A120 is a trained segmentation model 309.

At A130, the reconstruction model 305 and segmentation model 309 are trained/fine-tuned end to end, wherein the segmentation model 309 takes the output of the reconstruction model 305 as input, wherein the joint training includes a joint loss comprising at least a segmentation loss and a reconstruction loss. During the training, two supervised losses are calculated: one between the target image and the reconstructed image, referred to as the reconstruction loss, and the other between the segmentation target and the segmentation predictions, referred to as the segmentation loss. A discriminator model is also applied to the reconstructed image to generate the WGAN loss. The expression of the reconstruction loss can be rewritten as:

$${min}_{θ} α {ℒ}_{WGAN} + ( 1 - α ) [ ( 1 - γ ) {ℒ}_{RECON} + γ {ℒ}_{SEG} ] where$$

$${ℒ}_{WGAN} = - {f}_{w} ( {g}_{θ} ( y ) )$$

$${ℒ}_{RECON} = {‖ {g}_{θ} ( y ) - x ‖}_{{L}_{1} Comp}$$

$${ℒ}_{SEG} = {‖ {S}_{θ} ( {g}_{θ} ( y ) ) - {S}^{*} ( x ) ‖}_{CE}$$

where g_{Θ} is the generator model, f_{w} is the discriminator model, x is the target image, y is the undersampled k-space image, S_{Θ} is the segmentation model 309, and S* is the ground truth segmentation.

The Equation may also be written as:

$${min}_{θ} α \underbrace{[ - {f}_{w} ( {g}_{θ} ( y ) ) ]}_{WGAN loss} + ( 1 - α ) [ ( 1 - γ ) {‖ {g}_{θ} ( y ) - x ‖}_{\{ L 1 Comp \}} + γ \underbrace{{‖ {S}_{θ} ( {g}_{θ} ( y ) ) - {S}^{′} ( x ) ‖}_{\{ Dice \}}}_{Segmentation Loss} ]$$

The reconstruction loss is an L1 complex (applied directly on complex images), and the segmentation loss may be computed using a cross-entropy. In an embodiment, the model is trained using a gradient descent technique or a stochastic gradient descent technique. Both techniques attempt to minimize an error function defined for the model.

A140, the trained reconstruction model 305 is provided for use in a medical imaging procedure. In the application phase, image reconstruction is performed solely using the reconstruction model 305. Alternatively, both the reconstruction model 305 and segmentation model may be used during a medical imaging procedure. The framework is versatile, allowing for the utilization of various state-of-the-art architectures for both the reconstruction and segmentation modules.

Referring back to FIG. 1, the system 100 includes an operator interface 26, formed by an input and an output. The input may be an interface, such as interfacing with a computer network, memory, database, medical image storage, or other source of input data. The input may be a user input device, such as a mouse, trackpad, keyboard, roller ball, touch pad, touch screen, or another apparatus for receiving user input. The input may receive a scan protocol, imaging protocol, or scan parameters. An individual may select the input, such as manually or physically entering a value. Previously used values or parameters may be input from the interface. Default, institution, facility, or group set levels may be input, such as from memory to the interface.

The output is a display device but may be an interface. The images reconstructed from the scan are displayed. For example, an image of a region of the patient is displayed. A generated image of the reconstructed representation for a given patient is presented on a display of the operator interface 26. An analysis/interpretation, for example provided by the clinical task model 309 is also displayed on the display device. The control unit 20 may be configured to generate a report with analysis or a diagnosis for the patient that is displayed on the display device. The display is a CRT, LCD, plasma, projector, printer, or other display device. The display is configured by loading an image to a display plane or buffer. The display is configured to display the reconstructed MR image of the region of the patient. The operator interface may include form a graphical user interface (GUI) enabling user interaction with the control unit 20 and enables user modification in substantially real time.

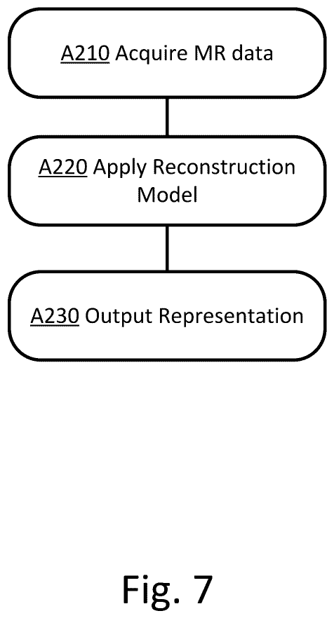

FIG. 7 depicts an example workflow for implementation of a trained reconstruction model 305. MR data is acquired and input into the trained reconstruction model 305. The reconstruction model 305 is configured by implementation of a new training pipeline that includes introducing a segmentation model 309 and a segmentation loss. The joint reconstruction-segmentation model 309 is trained end-to-end.

In Act A210, MR data is acquired using a SMS/PAT level of greater than two, in particular at least 2 and 6 respectively. Simultaneous Multi-Slice (SMS) uses a complex radiofrequency pulse to simultaneously stimulate at least two slices, phase-shifted from one another by 180. SMS TSE enables scan time reductions as a factor of slice acceleration. SMS DWI maximizes productivity for diffusion-weighted imaging of the brain, breast, abdomen and pelvis. With acceleration factors of up to 8, SMS for DTI and BOLD bring advanced techniques, such as pre-surgical mapping, into clinical routine. SMS RESOLVE further enables high-resolution, distortion-free DWI scans in significantly shorter time. For TSE and diffusion-weighted imaging (both with EPI and RESOLVE), slice acceleration may be used to reduce scan time and/or achieve higher spatial/diffusion resolution. For BOLD, slice acceleration may be used to increase temporal sampling of BOLD data, for higher sensitivity to BOLD signal changes, and/or to increase slice coverage/resolution.

In addition to SMS, parallel imaging may be used. When operated in parallel imaging (PI) mode, information about coil positions and sensitivities can be used to reduce the number of phase-encoding steps and speed up imaging. This is quantified by the PI acceleration factor (R), a number typically between 2 and 6. Because PI depends on estimation of coil sensitivities or their harmonic contributions, additional image-processing related artifacts are always present that are non-uniformly distributed. These reconstruction errors increase with the acceleration factor (R) but can be reduced by increasing the number of coil elements. PAT is the generic term for parallel imaging techniques. Other terms for PAT include “parallel imaging and partial parallel acquisition” two groups of PAT may be used. Image based methods, for example SENSE and mSENSE the PAT reconstruction is performed using the Fourier transformation. With k-space methods (SMASH, GRAPPA), the PAT reconstruction is performed prior to the Fourier transformation. PAT shortens the measurement time without degrading the image resolution. The PAT factor is a measure of the phase-encoding steps reduced through PAT. For example, a PAT factor of 2 each second step is skipped. This cuts the measurement time in half. In an embodiment, the system uses SMS2 and PAT6 to acquire MRI imaging data of a organ or region of a patient.

At act A220, the acquired MR data is input into a trained reconstruction model 305. In an embodiment the reconstruction model 305 uses a deep unrolled reconstruction model 305. The reconstruction model 305 is initially trained to generate a reconstructed image using, for example, a Wasserstein GAN for semi-supervised training. The GAN in combination with a pixel loss (L1) allows for semi-supervised training. The use of a WGAN improves the stability of learning. The training of the reconstruction model 305 is improved by adding a segmentation model 309 providing a segmentation-aware MRI reconstruction. One problem with the straightforward approach of only using a reconstruction model 305 is the use of loss functions that place equal emphasis on reconstruction errors across the field-of-view (e.g.: L1 loss). Embodiments use segmentation as a proxy task. The backpropogation of the segmentation error focuses the reconstruction model 305 on a zone of interest. Any additional clinical task model 309 may be used instead of the segmentation model 309. The clinical task model 309 is trained independently to output a clinically relevant task for the image provided by the reconstruction model 305. In an embodiment, the segmentation model 309 is trained using label smoothing. Label smoothing flattens the hard labels by assigning a uniform distribution over all other classes, which prevents over-confidence in the assigned label during training. For example, in spatially varying label smoothing may be used for incorporating structural label uncertainty by capturing ambiguity about object boundaries in expert segmentation maps.

Once the reconstruction model 305 and segmentation model 309 are independently trained, the combined segmentation aware reconstruction model 305 is trained end to end to fine tune the network. The output of the process is a reconstruction model 305 that is segmentation aware. During the medical imaging procedure, only the trained reconstruction model 305 may be used.

At act A230, a representation is output by the trained reconstruction model 305. The representation may be displayed to a user or provided for further analysis. The segmentation model 309 may also be used to provide analysis or diagnostics for the patient.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention. Independent of the grammatical term usage, individuals with male, female or other gender identities are included within the term.

The following is a list of non-limiting illustrative embodiments disclosed herein:

Illustrative embodiment 1. A method for using a semantic segmentation task as a surrogate task to focus a reconstruction of magnetic resonance data on segmented areas, the method comprising: training a reconstruction model to reconstruct an image from magnetic resonance data; training a segmentation model for segmentation of magnetic resonance images; joint training the reconstruction model and segmentation model end to end, wherein the segmentation model takes an output of the reconstruction model as input, wherein the joint training includes a joint loss comprising at least a segmentation loss and a reconstruction loss; and providing the trained reconstruction model.

Illustrative embodiment 2. The method of illustrative embodiment 1, wherein the magnetic resonance data comprises imaging data acquired using SMS2 and PAT6 settings.

Illustrative embodiment 3. The method according to one of the preceding embodiments, wherein the reconstruction model comprises an unrolled iterative image reconstruction model.

Illustrative embodiment 4. The method according to one of the preceding embodiments, wherein the reconstruction model comprises a generator network trained using an adversarial process.

Illustrative embodiment 5. The method according to one of the preceding embodiments, wherein the joint loss further comprises a WGAN loss.

Illustrative embodiment 6. The method according to one of the preceding embodiments, wherein the reconstruction loss is an L1 complex and the segmentation loss is computed using a cross-entropy loss.

Illustrative embodiment 7. The method according to one of the preceding embodiments, wherein the segmentation model comprises a U-net architecture including an encoder and a decoder.

Illustrative embodiment 8. The method according to one of the preceding embodiments, further comprising: applying the trained combined reconstruction model and segmentation model to acquired magnetic resonance data from a magnetic resonance imaging session of a patient.

Illustrative embodiment 9. The method according to one of the preceding embodiments, wherein during joint training when an artifact emerges in an output of the reconstruction model, the segmentation model fails to correctly identify a region including the artifact, resulting in a loss penalty.

Illustrative embodiment 10. A system for using a clinical task as a surrogate task for reconstruction of magnetic resonance data, the system comprising: a magnetic resonance scanner configured to acquire undersampled magnetic resonance data of a region of a patient; a memory configured to store a reconstruction model and a clinical task model; a processing unit configured to fine tune the reconstruction model by jointly training the reconstruction model and clinical task model end to end, the processing unit configured to input the undersampled magnetic resonance data into the trained reconstruction model which outputs a representation of the region of the patient; a display configured to display the representation.

Illustrative embodiment 11. The system according to one of the preceding embodiments, wherein the reconstruction model and clinical task model are independently trained prior to being fine-tuned.

Illustrative embodiment 12. The system according to one of the preceding embodiments, wherein the undersampled magnetic resonance data comprises imaging data acquired using SMS2 and PAT6.

Illustrative embodiment 13. The system according to one of the preceding embodiments, wherein the reconstruction model comprises an unrolled iterative image reconstruction model.

Illustrative embodiment 14. The system according to one of the preceding embodiments, wherein the clinical task model comprises a segmentation model.

Illustrative embodiment 15. The system according to one of the preceding embodiments, wherein jointly training includes a joint loss comprising at least a reconstruction loss, a WGAN loss, and a segmentation loss.

Illustrative embodiment 16. The system according to one of the preceding embodiments, wherein during jointly training of the reconstruction model and the segmentation model, when an artifact emerges in an output of the reconstruction model, the segmentation model fails to correctly identify a region of the artifact, resulting in a loss penalty.

Illustrative embodiment 17. A method for performing reconstruction on undersampled magnetic resonance data, the method comprising: acquiring the undersampled magnetic resonance data of a region of a patient; applying a reconstruction model, the reconstruction model jointly trained with a segmentation model as a surrogate task to focus the reconstruction of magnetic resonance data on segmented areas; outputting, by reconstruction model, a representation of the region of the patient; and displaying the representation.

Illustrative embodiment 18. The method according to one of the preceding embodiments, wherein the undersampled magnetic resonance data is acquired using SMS2 and PAT6.

Illustrative embodiment 19. The method according to one of the preceding embodiments, jointly training includes a joint loss comprising at least a reconstruction loss, a WGAN loss, and a segmentation loss

Illustrative embodiment 20. The method according to one of the preceding embodiments, wherein the reconstruction model and segmentation model are trained independently prior to being jointly trained.

1. A method for using a semantic segmentation task as a surrogate task to focus a reconstruction of magnetic resonance data on segmented areas, the method comprising:
training a reconstruction model to reconstruct an image from magnetic resonance data;
training a segmentation model for segmentation of magnetic resonance images;
joint training the reconstruction model and segmentation model end to end, wherein the segmentation model takes an output of the reconstruction model as input, wherein the joint training includes a joint loss comprising at least a segmentation loss and a reconstruction loss; and
providing the trained reconstruction model.

2. The method of claim 1, wherein the magnetic resonance data comprises imaging data acquired using SMS2 and PAT6 settings.

3. The method of claim 1, wherein the reconstruction model comprises an unrolled iterative image reconstruction model.

4. The method of claim 1, wherein the reconstruction model comprises a generator network trained using an adversarial process.

5. The method of claim 4, wherein the joint loss further comprises a WGAN loss.

6. The method of claim 1, wherein the reconstruction loss is an L1 complex and the segmentation loss is computed using a cross-entropy loss.

7. The method of claim 1, wherein the segmentation model comprises a U-net architecture including an encoder and a decoder.

8. The method of claim 1, further comprising:
applying the trained combined reconstruction model and segmentation model to acquired magnetic resonance data from an magnetic resonance imaging session of a patient.

9. The method of claim 1, wherein during joint training when an artifact emerges in an output of the reconstruction model, the segmentation model fails to correctly identify a region including the artifact, resulting in a loss penalty.

10. A system for using a clinical task as a surrogate task for reconstruction of magnetic resonance data, the system comprising:
a magnetic resonance scanner configured to acquire undersampled magnetic resonance data of a region of a patient;
a memory configured to store a reconstruction model and a clinical task model;
a processing unit configured to fine tune the reconstruction model by jointly training the reconstruction model and clinical task model end to end, the processing unit configured to input the undersampled magnetic resonance data into the trained reconstruction model which outputs a representation of the region of the patient;
a display configured to display the representation.

11. The system of claim 10, wherein the reconstruction model and clinical task model are independently trained prior to being fine-tuned.

12. The system of claim 10, wherein the undersampled magnetic resonance data comprises imaging data acquired using SMS2 and PAT6.

13. The system of claim 10, wherein the reconstruction model comprises an unrolled iterative image reconstruction model.

14. The system of claim 10, wherein the clinical task model comprises a segmentation model.

15. The system of claim 14, wherein jointly training includes a joint loss comprising at least a reconstruction loss, a WGAN loss, and a segmentation loss.

16. The system of claim 15, wherein during jointly training of the reconstruction model and the segmentation model, when an artifact emerges in an output of the reconstruction model, the segmentation model fails to correctly identify a region of the artifact, resulting in a loss penalty.

17. A method for performing reconstruction on undersampled magnetic resonance data, the method comprising:
acquiring the undersampled magnetic resonance data of a region of a patient;
applying a reconstruction model, the reconstruction model jointly trained with a segmentation model as a surrogate task to focus the reconstruction of magnetic resonance data on segmented areas;
outputting, by reconstruction model, a representation of the region of the patient; and
displaying the representation.

18. The method of claim 17, wherein the undersampled magnetic resonance data is acquired using SMS2 and PAT6.

19. The method of claim 17, jointly training includes a joint loss comprising at least a reconstruction loss, a WGAN loss, and a segmentation loss

20. The method of claim 17, wherein the reconstruction model and segmentation model are trained independently prior to being jointly trained.
